(19) United States
(12) Patent Application Publication
(10) Pub. No.: US 2025/0222928 A1
(43) Pub. Date: Jul. 10, 2025

(54) OFF-ROAD RAMP TRAVELLING VEHICLE ASSISTANCE SYSTEM AND METHOD

(71) Applicant: HEXAGON GEOSYSTEMS SERVICES AG, Heerbrugg (CH)

(72) Inventors: Peter SPRING, Thalwil (CH); Johannes HUBER, Walchwil (CH); Barbara HIRTZ, Zürich (CH)

(73) Assignee: HEXAGON GEOSYSTEMS SERVICES AG, Heerbrugg (CH)

(21) Appl. No.: 18/408,423

(22) Filed: Jan. 9, 2024

(51) Int. Cl. B60W 30/14; B60W 50/14

(52) U.S. Cl. CPC B60W 30/146; B60W 50/14; B60W 2300/125; B60W 2520/10; B60W 2530/10; B60W 2552/15; B60W 2554/802; B60W 2556/10; B60W 2556/50

(57) ABSTRACT

An off-road ramp travelling vehicle assistance system for a utility vehicle comprising an entry landmark marking a defined down-hill entry section of a ramp as a first ramp section. The entry landmark is located in advance of the start of the ramp and configured to be detectable by the utility vehicle. The utility vehicle comprises a slope meter for measuring a slope value and a location meter for measuring a location value of the utility vehicle. A vehicle's computer unit is configured to perform detection of the landmark when approaching the landmark and start of a ramp travelling vehicle assistance function in response to the detection.

### FIELD

The disclosure relates to a method and system for off-road ramp travelling vehicle assistance for a utility vehicle according to the claims.

### BACKGROUND

Off-road vehicle operations, especially on mining or construction sites, are entirely different from common street traffic. For example, in mining areas, mine vehicles generally travel between loading areas, unloading areas and other areas. Compared with structured roads in urban scenes, roads in mining areas have uneven or irregular boundaries, obstacles, and complex intersections. The road network is for instance slinging instead of a rectangular and orderly structure known from car roads. There are usually a lot more slopes, dusty roads, changing road conditions, and often even changing of entire road positions. Other particular problems are poor or lack of GNSS signal reception in places such as tunnels or deep pits.

Further, the vehicles involved are not seldom heavily loaded and their safe navigation through the site is very important to the workers involved, that is such utility vehicles may be exceedingly large and heavy, wherein control of such oversized vehicles is difficult and dangerous, e.g., because of limited operator visibility. Examples for such large sized heavy machine vehicles are dump trucks, excavators, and the like. For example, a mine haul truck is a dump truck capable of hauling up to several hundred tons of material. Furthermore, the mix of heavy and light vehicles on places such as a mining site also poses a danger due to berms at the road boundary, which can easily hide a light vehicle.

Furthermore, running a mining or construction site is very cost intense and therefore the navigation should also advantageously result in a frictionless transportation of goods as fast as possible and in particular without unnecessary interruption. In particular, mining is typically subject to high competitive pressure, wherein the mine site is typically run non-stop, i.e., day and night and under all weather conditions, and individual work steps have to be performed under high time pressure. In particular during the night or under adverse conditions as bad weather, a driver's sight may be severely reduced.

Accurate vehicle navigation is important in order to mitigate dangers of injury or property damage resulting from collision. Safe off-road operation of a utility vehicle, e.g., in an open-pit mine includes that the vehicle such as haul or mining trucks maintain defined speed limits, in particular when going down-hill on ramps, potentially with hundreds of tons auf hauling material loaded.

For assisting a driver of an off-road vehicle such as a mining truck, vehicle assistance systems are known in the art. Such systems can warn the operator in the cab audibly and visually or record speed violations. For example, the CN 113589825 A discloses a driving assistance system for an open-pit mine which is based on an electronic map.

A travelling vehicle assistance system further can actively intervene, for instance via automatically applying the so-called Retarder brake, providing a wear-less braking, or applying the service brake in case the operator did not react swiftly upon a warning. In other words, such a vehicle assistance system can partly take control of the truck, e.g., by cutting propulsion, brake or—where appropriate—cut the propulsion to the so-called “implements” such as the dump body with a haul truck or the boom/stick etc. with an excavator in defined situations if the driver does not react appropriately to a warning or alarm from the system.

However, a ramp travelling assistance system does not need to be active or to kick in during the whole travelling but only when the vehicle is actually on or at least approaching a ramp.

An electronic map of the mining site as for instance referred to in the system suggested by the above mentioned CN 113589825 A could be used to indicate ramps and trigger activation of the assistance system when the vehicle enters the ramp. However, a construction site—an open-pit mine is essentially a gigantic construction site—is a very dynamic environment. As already mentioned, roads are created and suspended on a continuous basis. Therefore, due to the rapid changes of the area, it is hard to keep up map data with the actual ramp configurations on all the vehicles. Electronic map data update happens often not timely enough and can be delayed, e.g., by communication restrictions or fails.

### SUMMARY

The present disclosure provides an improved off-road ramp travelling vehicle assistance system and method as well as computer program product for a utility vehicle.

The present disclosure relates to an off-road ramp travelling vehicle assistance system for a utility vehicle, preferably a mining vehicle assistance system, most preferably for mining trucks.

The vehicle assistance system comprises a, physical or virtual, entry landmark marking a defined down-hill entry section of a ramp as a first ramp section. The entry landmark is located in advance of the start of the ramp and configured to be detectable by the utility vehicle.

The utility vehicle comprises a detector for detecting a landmark. Above that, the vehicle has a speedometer for measuring a speed value of the utility vehicle and a computer unit.

Further, the vehicle has a slope meter for measuring a slope value of the utility vehicle, which slope meter optionally comprises a GNSS receiver. The vehicle further comprises a location meter for measuring an absolute or relative location value of the utility vehicle, e.g., said GNSS receiver for determining a GNSS-based position or a travel meter for determining a travelled distance of the utility vehicle as location value, e.g., a distance to a landmark and/or a distance travelled in a “level” slope state (no or little vehicle tilt), wherefore also inertial measurement sensors can be applied. Thereby, location is preferably determined in three dimensions, e.g., longitude, latitude and elevation.

Said computer unit is configured to perform detection-using said detector-of the landmark when approaching the landmark and start of a ramp travelling vehicle assistance function in response to the detection.

In course of the ramp travelling vehicle assistance function there is a repeated measurement of the vehicle's slope value and location value and a repeated determination of a vehicle's slope state based on multiple slope values and location state with respect to a ramp section based on at least one location value.

Further, in course of the assistance function, there is, based on a repeated measurement of vehicle speed values, a control of the vehicle's speed with regard to a defined speed limit, which speed limit may be ramp and/or slope specific.

Thereby, the ramp travelling vehicle assistance function provides different speed control modes which are automatically selectable depending on the determined slope state and location state.

In one embodiment, a location state is defined as the vehicle being inside or outside a ramp section. Preferably, “inside” or “outside” is determined by the vehicle's position relative to a landmark, e.g., via being close enough to the landmark for a certain amount of time. For example, the vehicle is considered being in a location state “inside” a ramp section when passing an entry landmark and considered being “outside” (quit the previous location state) when passing an exit landmark of the ramp. Thereby, optionally a vehicle's travel direction can be determined and considered, i.e., not only a position relative to a landmark is taken into account but a change of position relative to a landmark.

In one embodiment, the system comprises an exit landmark for defining a down-hill exit section of the ramp as a second, non-final ramp section, located in advance of the end of the ramp and configured to be detectable by the utility vehicle, too.

In a further developed embodiment, the computer unit is configured, in response to the detection of the exit landmark, to perform an amendment of the ramp travelling vehicle assistance function in that speed control is stopped. That is, in response to detection of an exit landmark and therewith an exit section of the ramp, hence, a location where normally less stringent control measures are needed, the extent of automatic monitoring or control is reduced in this embodiment.

In another further developed embodiment, the computer unit is configured to perform a determination of a ramp left state as location state with respect to the exit section and to end the execution of the ramp travelling vehicle assistance function in response thereto.

That is, based on a location state of the vehicle with respect to the exit landmark or exit section, respectively, the automatic monitoring and control is fully dropped.

In one embodiment, the slope states as well as the location states are discrete and discontinuous. Preferably, a slope state is defined as the vehicle having a slope with regard to the horizontal within a preset slope interval.

In one embodiment, the determination of the slope state comprises a location dependent state verification such that a slope state is considered determined only if at least an averaged slope value is within the according slope interval for a defined minimum travelled distance. Additionally or alternatively, a minimal confidence threshold is considered for slope state determination, i.e., the slope value has to be within the slope interval at least with some minimal pitch to the interval's lower or upper limit.

In one embodiment, the determination of the slope state or location state, respectively, comprises determination and consideration of a history of slope values or a history of location values, respectively. For instance, if measured slope values are decreasing or increasing in course of time or, preferably, travelled distance.

In one embodiment, the speed control modes comprise a driver warning mode for signalling to a driver a present overspeed and/or a nearing speed limit and/or a nearing down-hill ramp section as a first mode and a speed regulation mode for actively limiting or reducing the speed as a second mode. Preferably in the second mode, speed is automatically reduced by temporally take over from the utility vehicle's driver control of propulsion and/or brake of the utility vehicle.

In one embodiment, the landmark comprises a physically detectable feature and the detector comprises a sensor adapted thereto, e.g., an optical sign and a camera with image evaluation algorithm. Additionally or alternatively, the landmark comprises a radio signal transmitter and the detector comprises a radio signal receiver adapted thereto for receiving and evaluating the radio signals of the landmark. Additionally or alternatively, the landmark is virtual and comprises as a stored position stored on a permanent storage of the computer unit and the detector comprises an algorithm for detection of the landmark by comparing a vehicle's actual location value with the stored landmark position.

In one embodiment, a respective landmark comprises a code detectable by the detector for encoding an individual landmark and/or a type of landmark and therewith an individual ramp and/or type of ramp, e.g., an optically detectable code or an encoded radio signal, and the speed control modes or parameters thereof are selectable depending on the detected code.

In one embodiment, the computer unit is configured, in response to the detection of the landmark, to control a further aspect of the vehicle. Thereby, said control comprises to block or unblock a vehicle's working tool or body such as blocking a dump body when having passed an entry landmark of a ramp to prevent its unintentional activation when ramp travelling. Alternatively or additionally, said control of a further aspect is modifiable by modification of the landmark, e.g., by amending instructions sent by wireless signals of the landmark to the vehicle/computer unit.

In one embodiment, the landmark comprises a vehicle detector for detection of an approaching utility vehicle and the system comprises a landmark computer unit configured to control a ramp installation such as a boom gate, e.g., on top of a ramp, or traffic sign in response to the detection.

In one embodiment, speed limit and/or speed control mode, i.e., mode parameters or way of mode selection, is dependent on at least one of slope state, vehicle payload or weight, daytime, planned vehicle destination (e.g., given by a fleet management system) and/or proximity of another off-road user.

In one embodiment, the defined down-hill entry section of the ramp comprises a non-down-hill entry stretch.

The disclosure also relates to an off-road ramp travelling vehicle assistance method for a utility vehicle. According to the method, there is automatically detecting an entry landmark when approaching the landmark with the utility vehicle, the entry landmark defining a down-hill entry section of a ramp as a first ramp section, being located in advance of the start of the ramp and configured to be detectable by the utility vehicle.

Further, in course of the method there is repeatedly measuring a vehicle's slope value and a vehicle's location value, repeatedly determining a vehicle's slope state based on multiple slope values and location states with respect to a ramp section based on at least one location value.

Further, there is selecting a speed control mode from different speed control modes depending on the determined slope state and location state and controlling the vehicle's speed with regard to a defined, in particular ramp section specific, speed limit according to the selected speed control mode and based on a repeated measurement of speed values.

The disclosure also relates to computer program product having computer-executable instructions implemented for executing the inventive method as claimed, in particular when run on an inventive computer unit as claimed.

The present disclosure provides the advantage that a ramp travelling assistance function is started before the off-road vehicle, e.g., a mining truck, has started going down-hill on the ramp. The system and method allow to warn the operator and to intervene actively well in advance of the vehicle going over a ridge. Using this easy-to-deploy and lightweight approach allows to guarantee that an off-road vehicle has been slowed down to the target speed before it was going over a crest and before it is building up additional kinetic energy due to the gravity forces.

As another advantage, the inventive approach is not susceptible to changes in the gradient of the slope/ramp. On real off-road locations such as mines, ramps are rarely constructed “perfectly”, that is, being constructed using more or less constant slopes. On the opposite, steep stretches are followed by moderate ramps and not rarely some level parts are in between such as at switchbacks. With the inventive method and system, certain rules (such as, e.g., “hold a maximum speed of 30 km/h”) can be applied consistently despite such changing conditions. The definition of a “ramp” with this landmark-based approach is, in general, “a path from location or Point A to location or Point B”. Neither does this have to be a more-or-less straight line but could be of any shape. The momentary or current attitude of the vehicle-attitude in this context means the heading and slope, i.e., the yaw angle between the vehicle's front direction and a cardinal direction and the pitch angle between the vehicle's front direction and the horizontal plane-passing the ramp area does not matter at all. Switchbacks and (configurable) periods of level stretches and opposite grades can be tolerated without hindering the driving assistance.

Further, the inventive system can advantageously be configured to show no action when a vehicle enters the ramp area at the bottom and during climbing up, even when slightly exceeding the ramp speed. Any driving assistance function such as issuing an alarm is only triggered before or when travelling in down-hill direction. Hence, the speed limit does typically not apply to vehicles going up-hill direction on the ramp.

An experienced and skillful driver will build up some momentum in the flat to take it into the incline which the system does not inhibit by using accordingly placed exit landmarks, e.g., 100 m to 200 m before the incline transitions into the flat part. Hence, time and fuel can be saved. Accordingly, any automatic intervention such as braking and warning can be automatically stopped before the end of the slope such that for example the vehicle's down-hill momentum can be carried into the subsequent flat or level part of a haul road.

As another advantage, there is no limitation to the number of ramps which can be applied. Moreover, a flexible definition of ramp area/location is enabled. Landmarks can be determined automatically in the back office and potentially reviewed by a technician, whereby they can be generated in several ways. For instance, landmarks can be generated or defined using physical units by manually placing an extra unit or using an existing unit (e.g. on a shovel) such as “on-the-fly” definitions by placing a ramp landmark somewhere by a road construction crew. Landmarks can also be generated or defined as virtual landmarks by manually configuring a 2D position (and direction), automatically determining ramps in the back office based on vehicle positions of other vehicles and other vehicle types (light vehicles, graders). Landmarks can be automatically generated and/or (reviewed) by a person. This is not only advantageous in view of the highly dynamic road changes on sites such as an open-pit mine, but also for unforeseen events such as road block because of accidents or vehicle break down which may demand redirection of traffic.

As still another advantage, handling of junctions within the ramp is enabled and uncomplicated, e.g., when a ramp is left in between for reaching a bench, and there is generally great robustness against edge cases such as the vehicle taking a U-turn on a ramp or if a ramp is left through another, unmarked way.

### BRIEF DESCRIPTION OF THE DRAWINGS

By way of example only, preferred embodiments will be described more fully hereinafter with reference to the accompanying figures, wherein:

FIG. 1 shows a first example of an off-road ramp travelling vehicle assistance system and method;

FIG. 2 shows a scheme of an exemplary off-road ramp travelling assistance method; and

FIG. 3 shows a scheme for an exemplary slope state determination.

### DETAILED DESCRIPTION

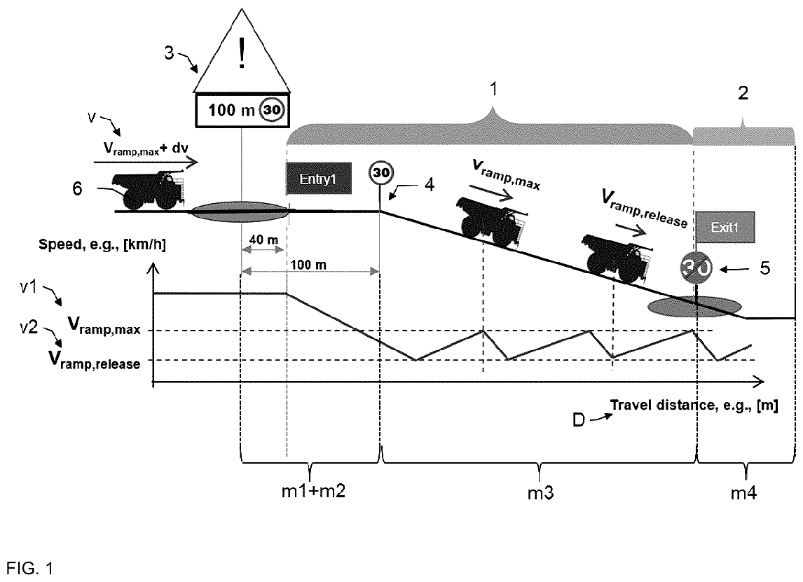

FIG. 1 shows a first example of an off-road ramp travelling vehicle assistance system for a utility vehicle whereby the upper part of the figure indicates schematically the vehicle 6 and its location in course of time when travelling a ramp and the lower part of the figure schematically indicates the speed v of the vehicle in dependence of the travelled distance D.

Beginning at the left side of the figure, it is shown that the vehicle 6, e.g., a haul or mining truck, approaches a ramp with a certain speed v. At this stage before the ramp, no driving assistance function is applied, yet, and the current speed of the vehicle 6 is higher than the speed v1, in the example 30 km/h, which is maximally allowed for travelling the ramp.

In order to assist the driver and to prevent entering the ramp with an overspeed, there is a landmark 3 installed e.g., 100 m before the actual down-hill region starts. In order to make the landmark visible to a human operator, it could be physically marked with a traffic sign similar to the one depicted in FIG. 1. A boundary around the landmark 3 such as the radius of 40 m indicated in the figure needs to be crossed by the vehicle in order to “trigger” the entering.

The truck 6 comprises some sort of detector for detecting a landmark 3, 5. For example, a landmark 3, 5 can be a virtual one or algorithmically defined. For instance, landmarks 3, 5 and their positions, e.g., defined longitude and latitude values, are stored on the vehicle's system device, that is, via configuration of the system's computer unit. Hence, such a landmark 3 is “invisible” and marked digitally on a map and stored on the mobile computer unit of each vehicle 6 this feature should be active. A landmark such as entry landmark 3 is detected in that the computer compares the vehicle's current position with the landmark's position and considers the landmark 3 as detected when approaching it, i.e., when the vehicle 6 is within a defined range to the landmark 3. Thereby, ramps could be automatically detected from vehicle data or from a detected road network.

In other words, a landmark 3, 5 is defined as part of the vehicle's computer configuration. The “computer program” running on the vehicle 6 carries a database of Entry and Exit landmarks 3, 5 with it, as part of its configuration. The current vehicle position (obtained via Global Satellite Navigation System, GNSS) is constantly compared against any of these saved landmark positions. As soon as the vehicle 6 enters the “landmark circle”, i.e., the distance between vehicle and Landmark “X” is smaller than, e.g., 40 m as indicated in the figure, this is treated as “triggering Landmark X”. A traffic sign as shown is then just for display purposes (human readable) but is not actually used for controlling the vehicle's behavior.

However, a physical mark such as a traffic sign can also be used as a “real” landmark 3, 5. In the exemplary case, the vehicle 6 can comprise for instance a camera, e.g., a greyscale, color, infrared or night vision camera, and computer unit which is configured to recognise the landmark 3 from a camera's image or video stream which recognition is the detection of the landmark 3, triggering the following ramp travelling assistance procedures.

Other detection means can be applied, adapted to the type or configuration of a landmark 3. For example, the landmark 3 and the vehicle 6 comprise radio transmitters which allow radio based detection. Such a radio-equipped physical unit may transmit to the passing vehicle 6 its current position (e.g., latitude=47°, longitude=8°), its state (e.g., away 60 m from ramp No. 27 where max speed is 30 km/h”) or its purpose (entry landmark) to ramp No. 27. A landmark 3 can also be embodied as a unit of a vehicle itself such as a more or less stationary excavator or drill which then serves as landmark besides its original function, too. For example, a loading shovel typically is at the end of a ramp and while the shovel is moving ahead with the cutting face, the ramp exit will automatically move with the shovel if the shovel's unit simultaneously acts as a landmark 5 indicating end or exit of a ramp.

Using any such easily installable or mobile signs or transmitters as the inventive landmarks deliver maximum flexibility to a system's operator. E.g., during construction of a new ramp section 1, 2, the ramp can be instantly marked by placing a sign which will be detected by any vehicle 6 without need for communication with or update of a vehicle 6.

In particular-but not only-in this case, landmark information can be transferred from one vehicle 6 to another vehicle 6 while passing each other. This data transfer can address cases where the travelling units 6 are subject to poor connectivity (Wi-Fi, LTE, etc.), e.g., while stationary located over a longer period of time at shadowed locations, in deep pits, or around tight corners.

Any detection of the entry landmark 3 starts a ramp travelling assistance function of the assistance system. This initiation based on landmark detection allows to have active alarm and intervention functions already before there is actually a ramp slope and therewith need for speed control. That is, the assistance function can be triggered already in the flat/level part on top of the ramp as depicted in the example.

For instance, the ramp travelling assistance function is started in response to the detection of entry landmark 3 either without delay after the detection or some distance after having passed it, e.g., the exemplified 40 m or said otherwise, at the actual beginning of ramp section 1.

In course of the ramp travelling assistance function, the location and slope of the truck 6 are monitored, that is, a position or distance value and a slope value are repeatedly measured. Slope or tilt is to be understood as angle/incline/rotation around the lateral vehicle axis. Location values can be distance measurements between two geolocations and/or the accumulation of a travelled distance. An example for applicable location meters for deriving said location values is a vehicle's odometer.

Such measurements can be GNSS based, too. For example, the slope value (i.e., 0 for level roads, +1 for 100% up-hill and −1 for 100% down-hill grades) is estimated from the GNSS measurements (horizontal and vertical speed measurements) and performing an intelligent, distance-based moving-window averaging. As one example of an alternative or additional slope measurement method, inclination sensors installed at the vehicle 6 can be used as slope meter.

In addition, the truck's speed v is monitored by repeatedly measuring vehicle speed values, for example using the vehicle's speedometer.

The location and slope measurements are used for determining a vehicle's slope state and a location state. That is, based on a location value, a location state of the vehicle with regard to a ramp section is determined such as “within ramp section 1”, “outside ramp section 2”, “ramp left” or “distance D from landmark N”.

In course of the driving assistance function, a speed control of the vehicle is executed. The speed control is based on the measured speed values which are compared to the applicable ramp speed limit. Speed control can comprise warning of the driver when exceeding the speed limit, for example, above a certain amount or percentage. Additionally, in particular in case the speed remains too high, an active speed regulation is applied for limiting or reducing the vehicle's speed, e.g., by automatic control of the propulsion or of the Retarder brake.

Thereby, the ramp travelling assistance function or system, respectively, provides at least two different speed control modes. The different speed control modes are automatically selected depending on said determined slope state and location state.

In the example, the automatic speed control mode selection based on slope and location state can be configured as follows:

A first speed control mode m1+m2 is active when the utility vehicle 6 has passed the entry landmark 3 or is within a defined distance to the landmark 3 and is entering ramp section 1 which is determined by the truck's location state (“less than 40 m away from entry landmark”) and slope state (“level”). In the first speed control mode m1+m2, a warning or notice is audibly or visibly given to the driver such as “ramp approaching” or a decent sound. The speed control can depend on the actual vehicle's speed, e.g., if the speed is far too high (e.g., 10 km/h as threshold), are more intense warning can pe outputted like: “Beware! Ramp ahead. You are going too fast!” and upon pending condition, e.g., after 5 seconds or 50 m travel distance, the alarming can be further escalated, and an intervention can be triggered.

Alternatively, when the operator has already slowed down the vehicle to the ramp speed limit at the Entry landmark, no speed control at all happens yet in this pre-ramp zone. That is, even no driver notification is active in this first part before ramp section 1; or a “zero” control mode is running, wherein the system observes the vehicle's state to readily activate a speed control, e.g., after a certain distance beyond landmark 3.

When the vehicle 6 is more than a certain distance, e.g., 40 m, away from the entry landmark resp. has passed the “Entry1”-point, or said otherwise is “inside ramp section 1” and has “level” slope state (hence has not yet passed point 4), a more articulated warning and/or an active automatic (limited or subtle) reduction of the speed is executed by the computer unit to aim at a vehicle's speed to be not higher than the allowed ramp speed limit when the vehicle 6 will pass point 4 or actually will start going down-hill.

When the vehicle 6 then actually goes down-hill, which is determined by a location state “within section 1” and “negative slope” as slope state, another control mode m3 is initiated with obligatory or strong automatic speed reduction. As shown in the exemplary figure, this further speed control mode m3 can be configured in such a way that the vehicle's speed does not fall short of a bottom speed limit v2, which is, e.g., the speed v2 with which the vehicle 6 can be released at the end 5 of the ramp.

As an option, the system can be configured to allow more than one speed control mode to be selectable for parallel execution of speed control modes m1-m4. For instance, a limited parallel execution of modes m1-m4 can be considered for a transitional border region between ramp sections 1, 2.

Hence, an exemplary resulting ramp travelling speed profile can be as shown in the lower part of FIG. 1 wherein the automatic speed control mode ensures that the vehicle's speed v is always in the interval defined by v1 and v2 when traveling the ramp, e.g., by alternatingly activating and deactivating brakes in such a way that the vehicle's speed v kind of oscillates between the upper speed limit v1 and the lower speed limit or release speed v2. Of course, other control configurations are possible such as permanent braking for providing a substantially constant speed v which can be made for example dependent on the determined slope state. Speed control should actually not kick in during normal operation. However, in an overspeed situation when going down a ramp a fast loaded haul truck 6 going down a ramp may not be stoppable at all (i.e., the brakes are not powerful enough, i.e., the Retarder brake cannot develop enough braking power to hold or reduce the vehicle speed). In such a scenario, there could also be a reporting to a back office service to show the alarm to control room operators or a safety manager and generate a report of such alarms.

Thereby, a speed control mode can be configured to depend on a vehicle's parameter or condition such as the actual payload or weight of a truck 6, which may include payload weight distribution. Dependence on payload or weight is also an option for a speed limit. That is, speed limits need not to be fixed but can be flexible, e.g., amended according to the current vehicle's weight or load and/or can be made depending on a slope state, too, wherefore for example different slopes or slope stretches within a ramp can be taken into account which might allow for different speed limits.

In the example, the system further comprises another landmark 5 for marking an exit section 2 of the ramp. This exit landmark 5 is located before and nearby the end of the ramp, is—likewise entry landmark 3—also configured to be detected by the vehicle's detector and indicates an exit zone 2 of the ramp. Detection of the exit landmark 3 triggers a reaction or different behavior of the computer unit.

In this example, the exit landmark 5 indicates that the ramp end is ahead and that the vehicle's slope is considered being of no (particular) importance any more for driving assistance. Also, exceeding the ramp speed limit is considered being not dangerous any more from point 5 on and the truck 6 can be let running without automatic intervention. To the contrary, using the potential energy provided by the final ramp step is sensible.

Hence, in the example, the computer unit is configured to, in response to detecting the exit landmark 5, amend the assistance function in that no longer slope is monitored or slope state is determined. Also, the speed control is modified, in particularly stopped—or in other words, a final speed control mode m4 is activated which is “no automatic speed action”.

As a final stage of operation, the computer unit can be configured to determine, based on the vehicle's location, e.g., distance to the exit landmark 5, a final location state, e.g., “ramp left” state. When such a “fully outside ramp” state is determined, the computer unit automatically ends the vehicle assistance function or sets it idle. That is, the automatic driving assistance is off or “sleeping” until it is activated once again in response to detection of an entry landmark 3.

Hence, entry landmark 3 as well as exit landmark 5 serve to define a ramp as a defined path from a point 3 to point 5 (which does neither have to be a straight line nor be at the same elevation, etc.) where based on determined slope state and location state of the vehicle 6, multiple speed control modes m1-m4 for optimized ramp travelling assistance are applied. In other words, landmarks 3, 5 in the sense of the present disclosure indicate the start and the end of a ramp as a stretch of road onto which specific rules apply.

Thereby, information about the planned destination of a vehicle 6 can be automatically considered in the automatic ramp travelling control. Such information, that can be received via a fleet management system, for example, can be used for selection of travelling modes m1-m4 or adapt mode parameters such as braking behavior or applicable speed limit.

As a further option, a respective landmark 3, 5 can comprise a code detectable by the vehicle's detector for encoding an individual landmark and/or a type of landmark and therewith an individual ramp and/or type of ramp. In such cases, the speed control modes m1-m4 are selectable depending on the detected landmark code. Alternatively or additionally, parameters such as speed limits within a respective control mode m1-m4 can be changed according to the encoded landmark/ramp. Therewith, a differentiation of ramp travelling assistance behaviour between different ramps or sort of ramps is possible.

As another option, the computer unit can be configured to control a further aspect of the vehicle 6 in response to the detection of the landmark 3, 5. For example, the landmarks 3 and 5 could be used to block or unblock a vehicle's working tool. In case of a haul truck, this could be to prevent the dump body from being raised between passing landmark 3 and 5. Also, said control of a further aspect can be modifiable by modification of the landmark 3, 5, that is, the control can be adapted by adaption of a landmark 3, 5, for instance by changing the above mentioned landmark code.

The other way round, so to say, a landmark 3, 5 can be used to control a ramp installation. For example, landmark 3 can comprise a vehicle detector for detection of an approaching utility vehicle 6 and a landmark computer unit configured to control a ramp installation in response to the detection. For example, a ramp gate can be opened, triggered by entry landmark 3 when notifying approaching truck 6 or a loading bay can be informed that after a certain time period truck 6 will arrive. Also, a landmark unit may feedback information such as the number of vehicles passed in each direction, their speed, their sanity state, etc. real-time to the dispatch and be logged for analysis and reporting.

Hence generally spoken, a landmark 3, 5 may serve for more than one purpose. Landmark units 3, 5 may further be used to control any behavior of vehicles in their vicinity, such as to prevent reversing or hoisting (i.e., raising the dump body), slowing down to give the right-away to other peer vehicles or to prevent vehicles from entering so-called “voids”, e.g., when there is a risk to drive over a ridge, etc. A landmark 3, 5 may also control infrastructure if there is a vehicle 6 in its vicinity, such as controlling flood lights, sprinklers, conveyor belts, or processing plants at loading and dumping/crusher sites, controlling test stations and entry gates based on some sanity checks performed on the vehicle.

A landmark 3, 5 can also have a double-function, e.g., as exit landmark for a first ramp and an entry landmark for a following, second ramp. Other functions of landmarks 3, 5 may include the marking of crossroads, e.g., to control traffic at a junction.

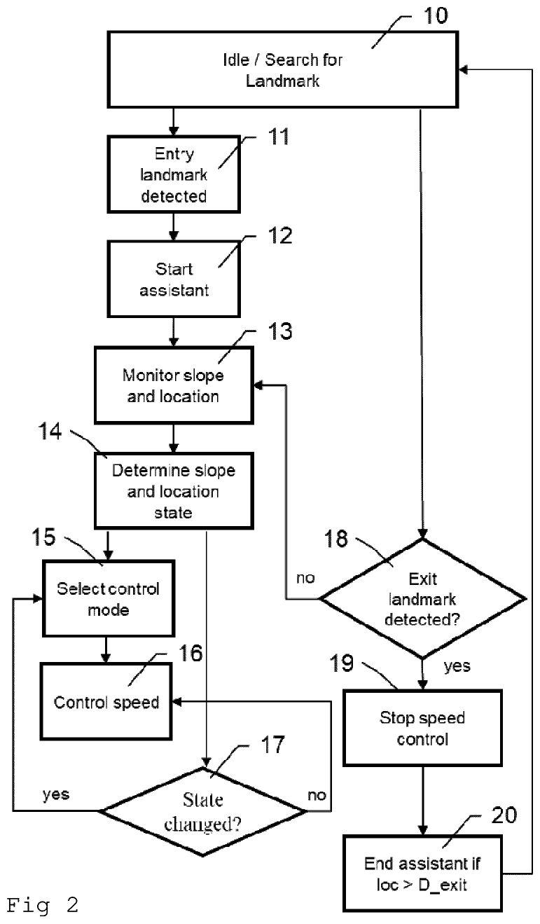

FIG. 2 shows an example of an off-road ramp travelling assistance method in form of a diagram.

First, the method comprises a searching for a landmark (step 10) in an “idle” system mode, by a vehicle's landmark detector as exemplified in context of FIG. 1 above. The landmark search continues in parallel to the following steps (in order to enable step 18; see below).

If an entry landmark, marking an entry area or nearing down-hill part of a ramp as described above, is recognized (step 11), the ramp travelling assistance function is launched (step 12).

In course of the assistance function, the vehicle's slope and its location are measured or monitored (step 13).

This sensed slope and location data is used for determining a slope state and a location state of the off-road vehicle (step 14).

Depending on the determined slope and location state, one of multiple available speed control modes is selected (step 15) and the vehicle's speed is controlled accordingly (step 16).

For example, upon approaching the entry landmark, i.e., when the distance to the landmark has fallen below a threshold (e.g., called “entry distance”) which qualifies as “entry landmark detected” (step 11), the system changes from an idle state to start of the ramp driving assistance (step 12) and, based on the slope and location state (which could be denoted for instance a “Entering on Top”-state), provides a first control mode. In this first speed control mode, the current vehicle speed (e.g., 42 km/h) is compared with the saved/configured maximum ramp speed (e.g., 30 km/h) and in case of a violation, further steps are taken by the system.

The usage of an entry marker allows to apply speed control, e.g., issuing an alarm, only when going down-hill; in other words, a speed limit does typically not apply to vehicles going up-hill on a ramp. The response to landmark detection also allows to start the speed assistance process before the truck has started going down-hill.

Steps 13 and 14 are repeatedly executed, that is slope and location or slope and location states, respectively, are surveilled. If slope and/or location state changes, step 15 of speed control mode selection is triggered, and another control mode is selected. If no state change is determined, the control mode is kept and speed control 16 is executed accordingly as previously.

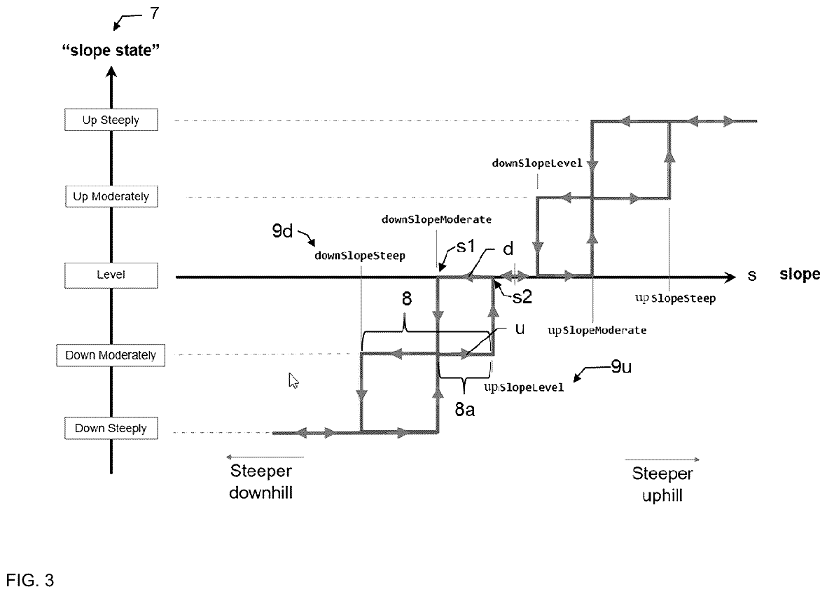

For example, once a down-hill slope type (i.e., “Down moderately” or “Down steeply” as denoted in following FIG. 3), has been detected, the ramp location state changes from “Entering on Top” to “Going Down”.

This procedure of monitoring vehicle state and reacting thereon by adapting speed control mode is maintained until an exit landmark is detected (step 18).

When an exit landmark is detected, the speed control is stopped (step 19). Also, slope monitoring can be stopped, as already mentioned above. This allows in particular to release any braking and warning before the end of the ramp/slope (such that the vehicle's momentum can be carried into the subsequent flat/level part of the road).

The location is further monitored as long as the location state indicates that the vehicle is still within an (exit) zone of the ramp. If this condition is gone, e.g., it is determined that the vehicle is out of a certain range from the exit landmark or ramp, the ramp travelling assistance function as such is ended (step 20).

Also, a travelled distance in a “level” slope state can be used as transition condition. If a defined distance has been travelled in “level” state, the system transitions back to “Idle”. Such a “MaxLevelStretchDistance”-threshold may be chosen very short (e.g., 10 m) for ramps which are rather strictly monotonously falling/rising. On the other hand, a value of 100 m may be chosen for ramps with longer plateau phases.

That is for instance, the vehicle's state transitions from “Going Down” to “Leaving at the Bottom” and back to “Idle”.

As indicated in the figure by the arrow on the right, the search for landmarks continuous, however, and if another entry landmark is detected, the procedure starts once again.

In a special case of overlapping ramps, a “Leaving at the Bottom state” (of the present ramp) may overlap with the “Entering on the Top state” of the next ramp. In such a case, any active ramp alarms and ramp assist interventions will not be dropped. The alarming and intervention states are held. This allows for a smooth transition from one ramp to the next one.

An advantage of inventive approach is that, e.g., three slope states “Going Down”, “Going Level” and “Going Up” are nested within four location states “Entering on Top”, “Leaving at the Bottom”, “Entering at the Bottom”, and “Leaving on Top”. This allows for example to keep a current control mode even in edge cases like a vehicle not steadily falling in altitude while going down a ramp (or vice versa) or when a truck takes a U-turn and goes back the opposite direction towards where it has entered. A vehicle may travel on short level stretches or even may go up-hill a certain distance without unnecessary speed control mode change. Thus, the estimated slope state may intermittently change from “Down Moderately” to “Level” while still the vehicle is controlled like “going down a ramp”.

The slope state and location state combination also prevents false assumptions and controls. For example, if a vehicle arrives from a bench at a crossroad from which both an up-hill and a down-hill ramp start from, each marked by a respective entry landmark, both of which are detected, the determined slope state will unambiguously indicate if a “down-hill” control mode or an “up-hill” control mode (or no control at all) is to be applied.

FIG. 3 shows a scheme for an exemplary slope state determination.

In this example, five slope states 7 are defined: “up steeply”, “up moderately”, “level”, “down moderately” and “down steeply” as indicated on the left side of FIG. 3. The right axis of FIG. 3 indicates the slope s of the vehicle as measured with sensing means as described above. For instance, the slope value s is estimated by averaging the quotient “vertical speed divided by horizontal speed” over a pre-defined distance (“slope distance”) chopped into sections.

In this example, each slope state 7 is associated with a range 8 of measured slope values s. That is, a currently determined slope state 7 is considered as prevailing as long as the sensed slope values s are within a certain interval of values s. Seen the other way round, not only one slope value, but a slope value interval s is associated with a slope state 7. In other words, a slope state 7 refers to a vehicle's slope or tilt within a preset slope or tilt interval. The slope value intervals 8 may be equal for slope states 7 or may be individually dimensioned for different slope states 7.

Hence, the slope states 7 are discrete and discontinuous. For example, the state “down moderately” is kept for the indicated slope value interval 8, i.e., as long as the measured slope values s are within this value range 8, and when the sensed slope value s exceeds a limit of the interval 8, another, significantly different slope state 7 is considered, e.g., “level”. Also, location states can be discrete and discontinuous, i.e., associated with a more or less wide range of vehicle's position values or an area, in particular positions relative to a landmark or an area defined by a landmark.

Of course, the number of predefined, different, and discrete slope states 7 can be larger or smaller than the exemplified five ones. The number of slope states 7 taken into account by the system as well as the slope values s associated therewith can, e.g., depend on the vehicle or ramp type or individual vehicle or ramp or this can depend on other variables such as an actual vehicle, weather or road condition.

Also, location states may depend on such factors, e.g., configured to be vehicle or ramp specific, e.g., depend on vehicle's health or load.

Thereby, a slope value hysteresis or direction of slope value change is considered. Slope values s—at least within some overlapping range—are associated with a “lower” slope state 7 in case of ascending slope value (e.g., arrow “u” in the figure) but with a “higher” slope state 7 in case of descending slope value 7 (e.g., arrow “d” in the figure).

That is, slope states 7 each represent a slope range or an interval of slope values with being sensitive to value history. It is discerned whether an actual slope value comes from a higher value (which brought it up onto that upper level) or from a lower value (which still keeps it on the lower level). So, the direction (marked “u” or “d” in the figure) of crossing of threshold values s1, s2 matters. Said otherwise, the slope values need to go a certain range “up” or “down” (difference between the two slope threshold values s1 and s2) before the slope state actually changes in order to prevent “toggling”/“jitter” when the input signals are noisy.

Additionally or alternatively, landmarks are configured to modify slope thresholds, i.e., threshold values s1, s2 are not fixed but can be modified in dependence on landmarks, e.g., upon detection of a landmark. Likewise, speed limits could be modifiable by landmarks resp. a speed limit could be set in response to a landmark detection.

Thus, at least some ranges of slope values are associated with one slope state 7 in some cases and with another one in other cases, depending on the criterion of ascending or descending slope values s.

For example, the indicated value range 8a belongs to the “down moderately” state 7 when the negative tilt of the vehicle goes towards level, but to “level” state 7 if the vehicle goes from level to down-hill. Hence, a history or trend of slope values s is considered for slope state determination.

Such a consideration of value trend can also be applied for determination of a location state.

Only when the limit of a defined value interval, in consideration of the direction u or d, is exceeded, the current slope (or location) state is changed to the next one. In the example, when the slope value s1 as a lower limit is reached, there is a down-change from “Level” to “Down Moderately”. On the other side, when the slope value s2 as an upper limit is reached, there is an up-change from “Down Moderately” to “Level”.

That is, a discrete slope state 7 or defined type of slope is calculated from the measured slope values s using a hysteresis function. Therewith, overhasty slope state changes are prevented but a change is initiated only if slope values are within a slope interval, e.g., 8a, or below a certain value, e.g., s2, with some confidence margin 8a to compensate for value fluctuations because of above mentioned measurement signal noise. This minimal “confidence” distance 8a can be equal for all states or can be state-specific resp. depend on the tilt range. Although aspects are illustrated above, partly with reference to some preferred embodiments, it must be understood that numerous modifications and combinations of different features of the embodiments can be made. All of these modifications lie within the scope of the appended claims.

1. An off-road ramp travelling vehicle assistance system for a utility vehicle, the vehicle assistance system comprising:
an entry landmark marking a defined down-hill entry section of a ramp as a first ramp section, the entry landmark being located in advance of the start of the ramp and configured to be detectable by the utility vehicle, the utility vehicle comprising:
a detector for detecting a landmark,
a slope meter, in particular comprising a GNSS receiver, for measuring a slope value of the utility vehicle,
a location meter for measuring a location value of the utility vehicle,
a speedometer for measuring a speed value of the utility vehicle,
a computer unit,
whereby the computer unit is configured to perform
detection of the landmark when approaching the landmark,
start of a ramp travelling vehicle assistance function in response to the detection,
whereby in course of the ramp travelling vehicle assistance function there is
a repeated measurement of the vehicle's slope value and location value,
a repeated determination of a vehicle's:
slope state based on multiple slope values and
location state with respect to a ramp section based on at least one location value, and
based on a repeated measurement of vehicle speed values, a control of the vehicle's speed with regard to a defined, in particular ramp section specific, speed limit, whereby the ramp travelling vehicle assistance function provides different speed control modes which are automatically selectable depending on the determined slope state and location state.

2. The vehicle assistance system according to claim 1, wherein the vehicle assistance system is embodied as a mining vehicle assistance system, in particular as a mining truck vehicle assistance system.

3. The vehicle assistance system according to claim 1, wherein the system comprises an exit landmark for defining a down-hill exit section of the ramp as a second, non-final ramp section, located in advance of the end of the ramp and configured to be detectable by the utility vehicle.

4. The vehicle assistance system according to claim 1, wherein a location state is defined as the vehicle being inside or outside a ramp section.

5. The vehicle assistance system according to claim 3, wherein the computer unit is configured, in response to the detection of the exit landmark, to perform an amendment of the ramp travelling vehicle assistance function to function without slope and/or slope state determination and/or without speed control.

6. The vehicle assistance system according to claim 3, wherein the computer unit is configured to perform a determination of a ramp left state as location state with respect to the exit section and to end the execution of the ramp travelling vehicle assistance function in response thereto.

7. The vehicle assistance system according to claim 1, wherein the slope states as well as the location states are discrete and discontinuous.

8. The vehicle assistance system according to claim 7, wherein a slope state is defined as the vehicle having a slope with regard to the horizontal within a preset slope interval.

9. The vehicle assistance system according to claim 8, wherein the determination of the slope state comprises a location dependent state verification such that a slope state is considered determined only if at least an averaged slope value is within the according slope interval considering a minimal confidence threshold.

10. The vehicle assistance system according to claim 1, wherein the determination of the slope state resp. of location state comprises determination and consideration of a slope value history resp. a location value history.

11. The vehicle assistance system according to claim 1, wherein the speed control modes comprise a:
driver warning mode for signalling to a driver a present overspeed and/or a nearing speed limit and/or a nearing down-hill ramp section and
a speed regulation mode for actively limiting or reducing the speed.

12. The vehicle assistance system according to claim 1, wherein:
the landmark comprises a physically detectable feature and the detector comprises a sensor adapted thereto and/or.
the landmark comprises a radio signal transmitter and the detector comprises a radio signal receiver adapted thereto and/or
the landmark is virtual and comprises as a stored position stored on a permanent storage of the computer unit and the detector comprises an algorithm for detection of the landmark by comparing a vehicle's actual location value with the stored landmark position.

13. The vehicle assistance system according to claim 1, wherein:
a respective landmark comprises a code detectable by the detector for encoding an individual landmark and/or a type of landmark and therewith an individual ramp and/or type of ramp and
the speed control modes or parameters thereof are selectable depending on the detected code.

14. The vehicle assistance system according to claim 1, wherein the computer unit is configured, in response to the detection of the landmark, to control a further aspect of the vehicle, whereby:
the control comprises to block or unblock a vehicle's working tool or body and/or
the control of a further aspect is modifyable by modification of the landmark.

15. The vehicle assistance system according to claim 1, wherein the landmark comprises a vehicle detector for detection of an approaching utility vehicle and the system comprises a landmark computer unit configured to control a ramp installation in response to the detection.

16. The vehicle assistance system according to claim 1, wherein the location meter is embodied as a travel meter for determining a travelled distance of the utility vehicle as location value.

17. The vehicle assistance system according to claim 1, wherein the speed control is dependent on at least one of:
slope state,
vehicle payload or weight,
daytime
proximity of another off-road user,
planned vehicle destination.

18. The vehicle assistance system according to claim 1, wherein the defined down-hill entry section of the ramp comprises a non-down-hill entry stretch.

19. An off-road ramp travelling vehicle assistance method for a utility vehicle, comprising automatically:
detecting an entry landmark when approaching the landmark with the utility vehicle, the entry landmark defining a down-hill entry section of a ramp as a first ramp section, being located in advance of the start of the ramp and configured to be detectable by the utility vehicle,
repeatedly measuring a vehicle's slope value and a vehicle's location value,
repeatedly determining a vehicle's:
slope state based on multiple slope values and
location state with respect to a ramp section based on at least one location value,
selecting a speed control mode from different speed control modes depending on the determined slope state and location state and
controlling the vehicle's speed with regard to a defined, in particular ramp section specific, speed limit according to the selected speed control mode and based on a repeated measurement of speed values.

20. A computer program product having computer-executable instructions stored in a non-transitory machine readable medium implemented for executing the method according to claim 19, when run on a computer unit.
